(19) United States
(12) Patent Application Publication
(10) Pub. No.: US 2024/0187732 A1
(43) Pub. Date: Jun. 6, 2024

(54) IMAGING DEVICE, METHOD OF DRIVING IMAGING DEVICE, AND PROGRAM

(71) Applicant: FUJIFILM Corporation, Tokyo (JP)

(72) Inventor: Hitoshi SAKURABU, Saitama-shi (JP)

(73) Assignee: FUJIFILM Corporation, Tokyo (JP)

(21) Appl. No.: 18/439,186

(22) Filed: Feb. 12, 2024

Related U.S. Application Data
(63) Continuation of application No. PCT/JP2022/027038, filed on Jul. 8, 2022.

(30) Foreign Application Priority Data
Aug. 25, 2021 (JP) 2021-137514

(51) Int. Cl. H04N 23/67; H04N 25/704

(52) U.S. Cl. CPC H04N 23/672; H04N 25/704

(57) ABSTRACT

The imaging device includes an image sensor that has a plurality of phase difference pixels and outputs phase difference information and a captured image, and at least one processor, in which the processor is configured to acquire subject distance information indicating a distance to a subject existing in a focusing target region and peripheral distance information indicating a distance to an object existing in a peripheral region of the focusing target region based on the phase difference information.

### CROSS-REFERENCE TO RELATED APPLICATION

This application is a continuation application of International Application No. PCT/JP2022/027038, filed Jul. 8, 2022, the disclosure of which is incorporated herein by reference in its entirety. Further, this application claims priority from Japanese Patent Application No. 2021-137514 filed on Aug. 25, 2021, the disclosure of which is incorporated herein by reference in its entirety.

### BACKGROUND

### 1. Technical Field

A technique of the present disclosure relates to an imaging device, a method of driving the imaging device, and a program.

### 2. Description of the Related Art

JP2018-017876A discloses an imaging device including a focus detection means that detects a defocus amount for each of a plurality of predetermined focus detection regions from an image signal output from an imaging element, a generation means that generates distance distribution information based on the defocus amount, a focus adjustment means that performs focus adjustment based on the distance distribution information and the defocus amount, and a control means that performs control so as to perform imaging by setting a stop included in an imaging optical system to a first stop value to be a first depth of field when the distance distribution information is generated by the generation means and perform imaging by setting the stop to a second stop value to be a second depth of field shallower than the first depth of field when the focus adjustment is performed by the focus adjustment means.

JP2019-023679A discloses an imaging device including an imaging means that generates a captured image, a distance map acquisition means, a distance map management means, a focus range instruction means, a focusable determination means, a lens setting determination means, and a display means, in which the focusable determination means determines whether a range instructed by the focus range instruction means is a refocusable range, the lens setting determination means determines whether to change a lens setting in accordance with a determination result of the focusable determination means, and the display means performs display related to a lens setting change in accordance with a determination result of the lens setting determination means.

JP2017-194654A discloses an imaging device including an imaging element having pupil-divided pixels, a reading means that reads a signal from each of the pixels of the imaging element, a setting means that sets a region for reading signals having different parallaxes from the pupil-divided pixels by the reading means, a first information acquisition means that acquires first depth information for detecting a subject by using a signal read from a first region set by the setting means, a second information acquisition means that acquires second depth information for detecting a focus state of the subject by using a signal read from a second region set by the setting means, and a control means that variably controls a ratio of a screen in which the first region is set by the setting means and a ratio of a screen in which the second region is set by the setting means.

### SUMMARY

One embodiment according to a technique of the present disclosure provides an imaging device, a method of driving the imaging device, and a program capable of following a subject accurately.

In order to achieve the above object, an imaging device according to an embodiment of the present disclosure comprises an image sensor that has a plurality of phase difference pixels and outputs phase difference information and a captured image, and at least one processor, in which the at least one processor is configured to acquire subject distance information indicating a distance to a subject existing in a focusing target region and peripheral distance information indicating a distance to an object existing in a peripheral region of the focusing target region based on the phase difference information.

The imaging device according to the embodiment of the present disclosure preferably comprises a focus lens, in which the at least one processor is configured to perform focusing control of controlling a position of the focus lens based on the subject distance information.

The at least one processor is preferably configured to detect an object existing between the subject and the imaging device based on the subject distance information and the peripheral distance information, and in a case where a distance within an angle of view of the object with respect to the subject is reduced, change the focusing control.

The at least one processor is preferably configured to estimate a position of the subject based on a past position of the subject in a case where the object blocks the subject.

The at least one processor is preferably configured to move the focusing target region to the estimated position of the subject, and in a case where the subject is not detected from the focusing target region after the movement, move the focusing target region to a position of the object.

The at least one processor is preferably configured to record the captured image and distance distribution information corresponding to the captured image, and acquire the subject distance information and the peripheral distance information based on the distance distribution information.

The at least one processor is preferably configured to generate and record an image file including the captured image and the distance distribution information.

The peripheral distance information included in the distance distribution information preferably includes a relative distance of an object in the peripheral region with respect to the focusing target region.

The at least one processor is preferably configured to perform correction processing on at least one of the focusing target region or the peripheral region of the captured image based on the distance distribution information.

The at least one processor is preferably configured to change the correction processing on the object in accordance with the relative distance.

The correction processing on the object is preferably chromatic aberration correction.

The distance distribution information preferably includes distance information corresponding to a plurality of pixels constituting the captured image, and the at least one processor is preferably configured to composite a stereoscopic image with the captured image by using the distance information to generate a composite image.

A method according to an embodiment of the present disclosure is a method of driving an imaging device including an image sensor that has a plurality of phase difference pixels and outputs phase difference information and a captured image, the method comprising acquiring subject distance information indicating a distance to a subject existing in a focusing target region and peripheral distance information indicating a distance to an object existing in a peripheral region of the focusing target region based on the phase difference information.

A program according to an embodiment of the present disclosure is a program that operates an imaging device including an image sensor that has a plurality of phase difference pixels and outputs phase difference information and a captured image, the program causing the imaging device to perform processing of acquiring subject distance information indicating a distance to a subject existing in a focusing target region and peripheral distance information indicating a distance to an object existing in a peripheral region of the focusing target region based on the phase difference information.

### BRIEF DESCRIPTION OF THE DRAWINGS

Exemplary embodiments according to the technique of the present disclosure will be described in detail based on the following figures, wherein:

FIG. 1 is a diagram showing an example of an internal configuration of an imaging device,

FIG. 2 is a diagram showing an example of a configuration of an imaging pixel,

FIG. 3 is a diagram showing an example of a configuration of a phase difference pixel,

FIG. 4 is a diagram showing an example of a pixel array of an imaging sensor,

FIG. 5 is a block diagram showing an example of a functional configuration of a processor,

FIG. 6 is a diagram conceptually showing an example of distance distribution information acquisition processing,

FIG. 7 is a diagram conceptually showing an example of encoding processing by an LBE method,

FIG. 8 is a diagram conceptually showing an example of a shift operation processing, and shows a shift operation in which ΔX=0,

FIG. 9 is a diagram conceptually showing an example of the shift operation processing, and shows the shift operation when ΔX=−1,

FIG. 10 is a diagram conceptually showing an example of sub-pixel interpolation processing,

FIG. 11 is a diagram conceptually showing one example of focusing control,

FIG. 12 is a diagram for describing occlusion of a subject due to an object existing between the subject and the imaging device,

FIG. 13 is a flowchart showing an example of AF control,

FIG. 14 is a diagram conceptually showing an example of moving the AF area in a case where occlusion occurs to the subject due to an object,

FIG. 15 is a diagram showing an example of a case where the AF area is moved again,

FIG. 16 is a flowchart showing an example of AF control according to a first modification example,

FIG. 17 is a diagram conceptually showing an example of correction processing according to a second modification example,

FIG. 18 is a diagram conceptually showing chromatic aberration correction, and

FIG. 19 is a diagram conceptually showing an example of processing of generating a composite image.

### DETAILED DESCRIPTION

An example of an embodiment according to a technique of the present disclosure will be described with reference to the accompanying drawings.

First, terms that are used in the following description will be described.

In the following description, “IC” is an abbreviation for “integrated circuit”. “CPU” is an abbreviation for “central processing unit”. “ROM” is an abbreviation for “read-only memory”. “RAM” is an abbreviation for “random access memory”. “CMOS” is an abbreviation for “complementary metal oxide semiconductor”.

“FPGA” is an abbreviation for “field programmable gate Array”. “PLD” is an abbreviation for “programmable logic Device”. “ASIC” is an abbreviation for “application specific integrated circuit”. “OVF” is an abbreviation for “optical view finder”. “EVF” is an abbreviation for “electronic view finder”. “JPEG” is an abbreviation for “joint photographic experts group”. “AF” is an abbreviation for “autofocus”. “LBE” is an abbreviation for “local binary encoding”. “LBP” is an abbreviation for “local binary pattern”. “AR” is an abbreviation for “augmented reality”.

The technique of the present disclosure will be described by using a lens-interchangeable digital camera as an example of one embodiment of an imaging device. The technique of the present disclosure is not limited to the lens interchangeable type, and can also be applied to a lens-integrated digital camera.

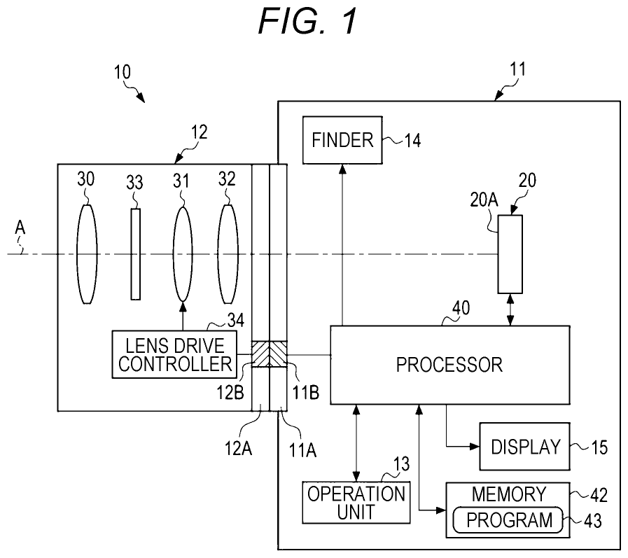

FIG. 1 shows an example of a configuration of an imaging device 10. The imaging device 10 is a lens-interchangeable digital camera. The imaging device 10 includes a body 11 and an imaging lens 12 that is interchangeably mounted on the body 11. The imaging lens 12 is attached to a front surface side of the body 11 with a camera-side mount 11A and a lens-side mount 12A interposed therebetween.

The body 11 is provided with an operation unit 13 including a dial, a release button, and the like. An operation mode of the imaging device 10 includes, for example, a still image imaging mode, a video imaging mode, and an image display mode. The operation unit 13 is operated by a user in a case where an operation mode is set. The operation unit 13 is operated by the user in a case where execution of imaging a still image or imaging a video is started.

The body 11 is provided with a finder 14. Here, the finder 14 is a hybrid finder (registered trademark). The hybrid finder is a finder in which, for example, an optical viewfinder (hereinafter, referred to as “OVF”) and an electronic viewfinder (hereinafter, referred to as “EVF”) are selectively used. The user can observe an optical image or a live view image of a subject projected by the finder 14 through a finder eyepiece portion (not shown).

A display 15 is provided on a rear surface side of the body 11. The display 15 displays an image based on an image signal obtained by imaging, various menu screens, and the like. The body 11 and the imaging lens 12 are electrically connected to each other by contacting an electric contact 11B provided on the camera-side mount 11A into contact with an electric contact 12B provided on the lens-side mount 12A.

The imaging lens 12 includes an objective lens 30, a focus lens 31, a rear-end lens 32, and a stop 33. Each member is arranged along an optical axis A of the imaging lens 12 in order of the objective lens 30, the stop 33, the focus lens 31, and the rear-end lens 32 from an object side. The objective lens 30, the focus lens 31, and the rear-end lens 32 constitute an imaging optical system. The type, number, and arrangement order of the lenses constituting the imaging optical system are not limited to the example shown in FIG. 1.

The imaging lens 12 has a lens drive controller 34. The lens drive controller 34 is constituted by, for example, a CPU, a RAM, a ROM, and the like. The lens drive controller 34 is electrically connected to a processor 40 in the body 11 via the electric contact 12B and the electric contact 11B.

The lens drive controller 34 drives the focus lens 31 and the stop 33 based on a control signal transmitted from the processor 40. The lens drive controller 34 performs drive control of the focus lens 31 based on a control signal for focusing control transmitted from the processor 40 in order to adjust an in-focus position of the imaging lens 12. The processor 40 performs focus adjustment of a phase difference method.

The stop 33 has an aperture whose aperture diameter is variable around the optical axis A. The lens drive controller 34 controls driving of the stop 33 based on a control signal for stop adjustment transmitted from the processor 40 in order to adjust the amount of incidence light on a light receiving surface 20A of the imaging sensor 20.

The imaging sensor 20, the processor 40, and a memory 42 are provided inside the body 11. The operations of the imaging sensor 20, the memory 42, the operation unit 13, the finder 14, and the display 15 are controlled by the processor 40.

The processor 40 is constituted by, for example, a CPU, a RAM, a ROM, and the like. In this case, the processor 40 executes various processing based on the program 43 stored in the memory 42. The processor 40 may be configured by an aggregate of a plurality of IC chips.

The imaging sensor 20 is, for example, a CMOS type image sensor. The imaging sensor 20 is disposed such that the optical axis A is orthogonal to the light receiving surface 20A and the optical axis A is positioned at the center of the light receiving surface 20A. Light (subject image) that has passed through the imaging lens 12 is incident on the light receiving surface 20A. A plurality of pixels that generate image signals by performing photoelectric conversion are formed on the light receiving surface 20A. The imaging sensor 20 generates and outputs an image signal by photoelectrically converting light incident on each of the pixels. The imaging sensor 20 is an example of an “image sensor” according to the technique of the present disclosure.

In addition, a color filter array of a Bayer array is disposed on the light receiving surface 20A of the imaging sensor 20, and any one of color filters of red (R), green (G), or blue (B) is disposed to face each pixel. Some of the plurality of pixels arranged on the light receiving surface 20A of the imaging sensor 20 are phase difference pixels for acquiring parallax information. The phase difference pixel is not provided with a color filter. Hereinafter, a pixel provided with a color filter is referred to as a normal pixel.

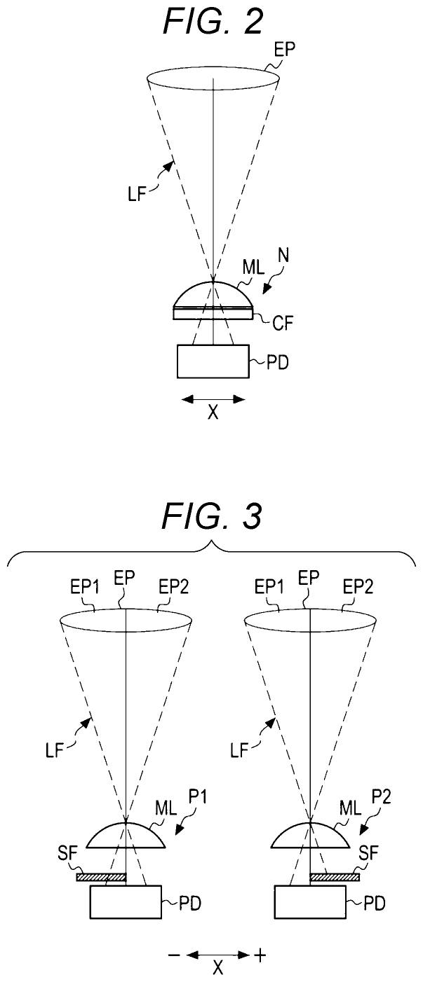

FIG. 2 shows an example of a configuration of an imaging pixel N. FIG. 3 shows an example of a configuration of phase difference pixels P1 and P2. Each of the phase difference pixels P1 and P2 receives one of luminous fluxes divided in an X direction around a principal ray.

As shown in FIG. 2, the imaging pixel N includes a photodiode PD as a photoelectric conversion element, a color filter CF, and a microlens ML. The color filter CF is disposed between the photodiode PD and the microlens ML.

The color filter CF is a filter that transmits light of any color of R, G, or B. The microlens ML collects a luminous flux LF incident from an exit pupil EP of the imaging lens 12 substantially at the center of the photodiode PD through the color filter CF.

As shown in FIG. 3, each of the phase difference pixels P1 and P2 includes the photodiode PD, a light-shielding layer SF, and the microlens ML. Similar to the imaging pixel N, the microlens ML collects the luminous flux LF incident from the exit pupil EP of the imaging lens 12 substantially at the center of the photodiode PD.

The light-shielding layer SF includes a metal film or the like, and is disposed between the photodiode PD and the microlens ML. The light-shielding layer SF shields a part of the luminous flux LF incident on the photodiode PD through the microlens ML.

In the phase difference pixel P1, the light-shielding layer SF shields light on a negative side in the X direction with respect to the center of the photodiode PD. That is, in the phase difference pixel P1, the light-shielding layer SF causes the luminous flux LF from the exit pupil EP1 on the negative side, to be incident on the photodiode PD and shields the luminous flux LF from an exit pupil EP2 on a positive side in the X direction.

In the phase difference pixel P2, the light-shielding layer SF shields light on the positive side in the X direction with respect to the center of the photodiode PD. That is, in the phase difference pixel P2, the light-shielding layer SF causes the luminous flux LF from the exit pupil EP2 on the positive side, to be incident on the photodiode PD and shields the luminous flux LF from the exit pupil EP1 on the negative side in the X direction.

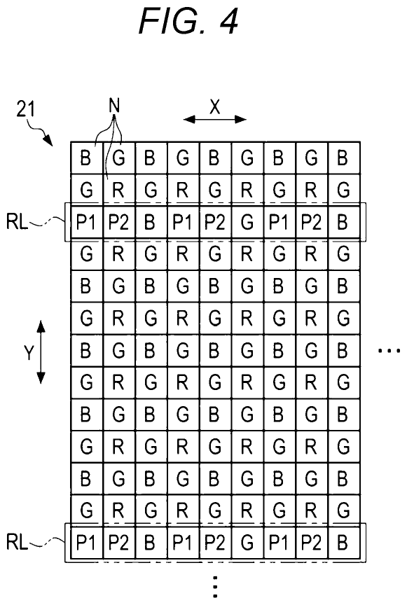

FIG. 4 shows an example of a pixel array of the imaging sensor 20. “R” in FIG. 4 represents the imaging pixel N provided with the color filter CF of R. “G” represents the imaging pixel N provided with the color filter CF of G. “B” represents the imaging pixel N provided with the color filter CF of B. The color arrangement of the color filters CF is not limited to the Bayer arrangement, and may be another color arrangement.

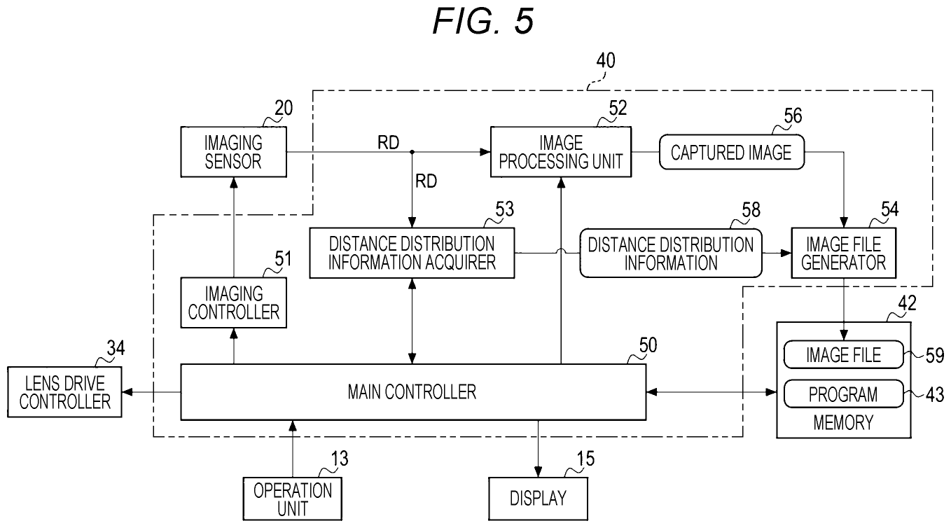

Rows RL including the phase difference pixels P1 and P2 are arranged for every ten pixels in a Y direction. In each of the rows RL, a pair of phase difference pixels P1 and P2, and one imaging pixel N are repeatedly arranged in the Y direction. The arrangement pattern of the phase difference pixels P1 and P2 is not limited to the example shown in FIG. 4, and may be, for example, a pattern in which a plurality of phase difference pixels are arranged in one microlens ML as shown in FIG. 5 attached to JP2018-56703A.

FIG. 5 is a block diagram showing an example of a functional configuration of the processor 40. The processor 40 executes processing in accordance with the program 43 stored in the memory 42 to implement various functional units. As shown in FIG. 5, for example, a main controller 50, an imaging controller 51, an image processing unit 52, a distance distribution information acquirer 53, and an image file generator 54 are implemented in the processor 40.

The main controller 50 integrally controls the operation of the imaging device 10 based on an instruction signal input from the operation unit 13. The imaging controller 51 controls the imaging sensor 20 to execute imaging processing of causing the imaging sensor 20 to perform an imaging operation. The imaging controller 51 drives the imaging sensor 20 in the still image imaging mode or the video imaging mode.

The image processing unit 52 performs various image processing on a RAW image RD output from the imaging sensor 20 to generate a captured image 56 in a predetermined file format (for example, a JPEG format). The captured image 56 output from the image processing unit 52 is input to the image file generator 54. The captured image 56 is an image generated based on a signal output from the imaging pixel N.

The distance distribution information acquirer 53 acquires distance distribution information 58 by performing a shift operation based on signals output from the phase difference pixels P1 and P2 (see FIG. 3) in an imaging area 60 in the RAW image RD output from the imaging sensor 20. The distance distribution information 58 acquired by the distance distribution information acquirer 53 is input to the image file generator 54.

The image file generator 54 generates an image file 59 including the captured image 56 and the distance distribution information 58, and records the generated image file 59 in the memory 42.

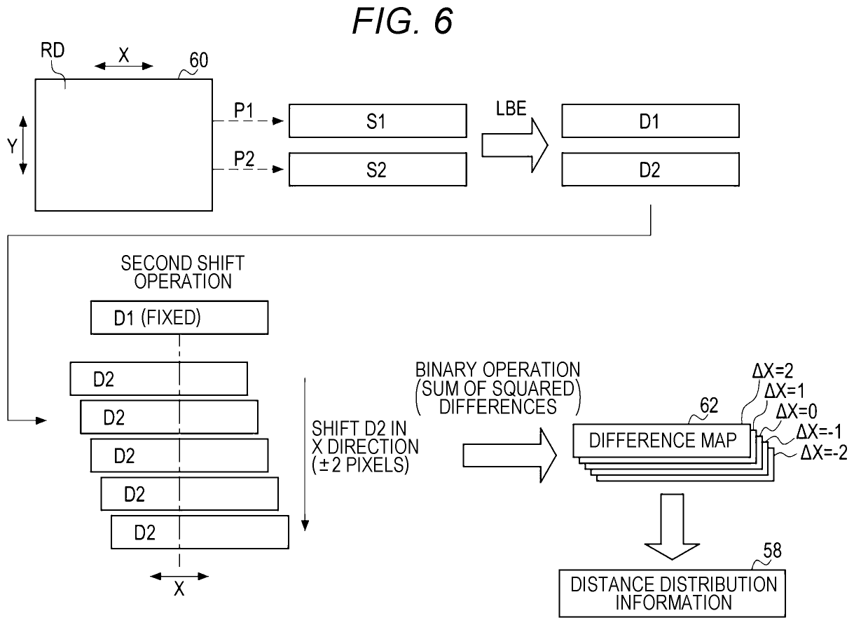

FIG. 6 conceptually shows an example of distance distribution information acquisition processing by the distance distribution information acquirer 53. As shown in FIG. 6, based on the RAW image RD, the distance distribution information acquirer 53 acquires a first signal S1 from the plurality of phase difference pixels P1 included in the imaging area 60, and acquires a second signal S2 from the plurality of phase difference pixels P2 included in the imaging area 60. The first signal S1 is constituted by a pixel signal output from the phase difference pixel P1. The second signal S2 is constituted by a pixel signal output from the phase difference pixel P2. The imaging area 60 includes approximately 2000 phase difference pixels P1 and approximately 2000 phase difference pixels P2 in the X direction.

The distance distribution information acquirer 53 encodes the first signal S1 and the second signal S2 to acquire first phase difference information D1 and second phase difference information D2. The distance distribution information acquirer 53 performs encoding by using a local binary encoding (LBE) method. The LBE method refers to a method of converting phase difference information for each pixel or each pixel group into binary information according to a predetermined standard. Specifically, the distance distribution information acquirer 53 converts the first signal S1 into the first phase difference information D1 by the LBE method, and converts the second signal S2 into the second phase difference information D2 by the LBE method. In the shift operation, each pixel of the first phase difference information D1 and the second phase difference information D2 is represented by a binary local binary pattern (hereinafter, referred to as LBP) encoded by the LBE method.

The distance distribution information acquirer 53 performs the shift operation by using the first phase difference information D1 and the second phase difference information D2. In the shift operation, the distance distribution information acquirer 53 performs a correlation operation between the first phase difference information D1 and the second phase difference information D2 while fixing the first phase difference information D1 and shifting the second phase difference information D2 pixel by pixel in the X direction to calculate a sum of squared difference.

A shift range in which the distance distribution information acquirer 53 shifts the second phase difference information D2 in the shift operation is, for example, a range of −2≤ ΔX≤ 2. ΔX represents a shift amount in the X direction. In the shift operation, the processing speed is increased by narrowing the shift range.

Although details will be described later, the distance distribution information acquirer 53 calculates the sum of squared difference by performing a binary operation. The distance distribution information acquirer 53 performs the binary operation on the LBPs included in corresponding pixels of the first phase difference information D1 and the second phase difference information D2. The distance distribution information acquirer 53 generates a difference map 62 by performing the binary operation every time the second phase difference information D2 is shifted by one pixel. As a result, the difference map 62 is generated for each of ΔX=2, 1, 0, −1, and −2. Each pixel of the difference map 62 is represented by an operation result of the binary operation.

Although details will be described later, the distance distribution information acquirer 53 generates the distance distribution information 58 by performing processing such as sub-pixel interpolation based on the plurality of difference maps 62.

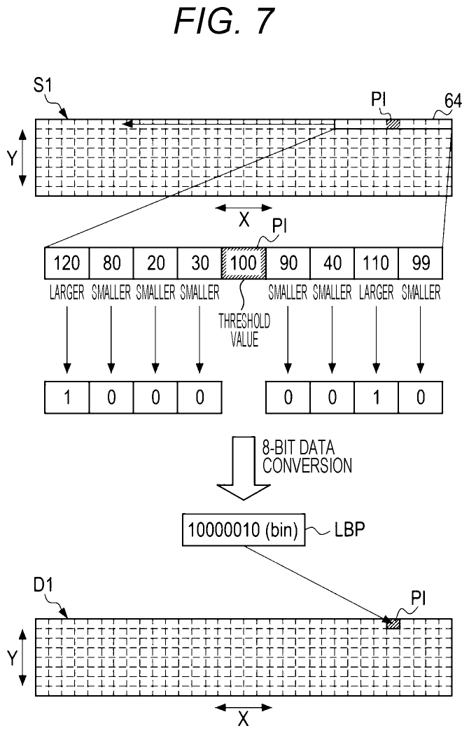

FIG. 7 conceptually shows an example of encoding processing by the LBE method. As shown in FIG. 7, an extraction region 64 is set in the first signal S1, and a plurality of pixel values are acquired from the set extraction region 64. The pixel value is a value of the pixel signal output from the phase difference pixel P1. For example, the extraction region 64 is a region including nine pixels arranged in the X direction. The size and shape of the extraction region 64 can be appropriately changed.

The distance distribution information acquirer 53 sets the pixel at the center of the extraction region 64 as a pixel-of-interest PI, and sets the pixel value of the pixel-of-interest PI as a threshold value. Next, the distance distribution information acquirer 53 compares the value of a peripheral pixel with the threshold value, and binarizes the value as “1” in a case where the value is equal to or larger than the threshold value, and as “0” in a case where the value is smaller than the threshold value. Next, the distance distribution information acquirer 53 converts the binarized values of eight peripheral pixels into 8-bit data to obtain LBP. Then, the distance distribution information acquirer 53 replaces the value of the pixel-of-interest PI with LBP.

The distance distribution information acquirer 53 calculates the LBP while changing the extraction region 64 pixel by pixel and replaces the value of the pixel-of-interest PI with the calculated LBP to generate first phase difference information D1.

The encoding processing of generating the second phase difference information D2 is similar to the encoding processing of generating the first phase difference information D1, and thus the description thereof will be omitted.

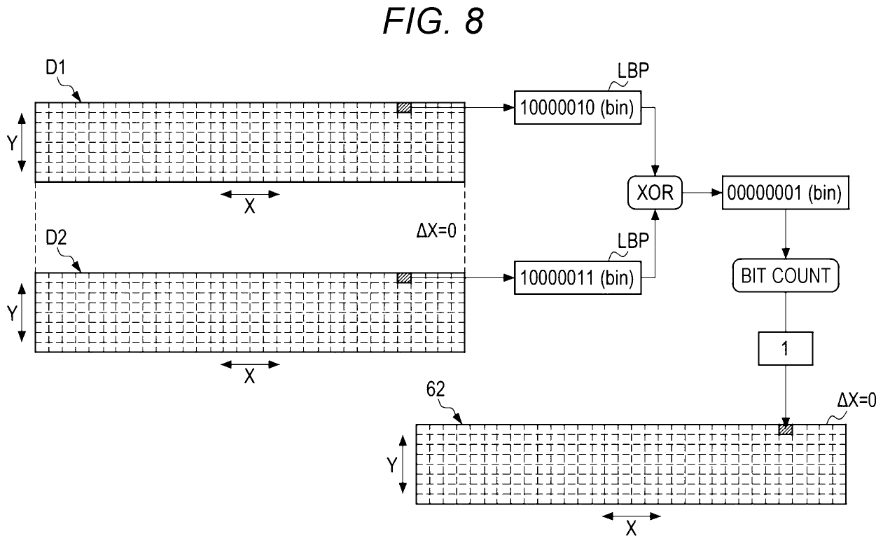

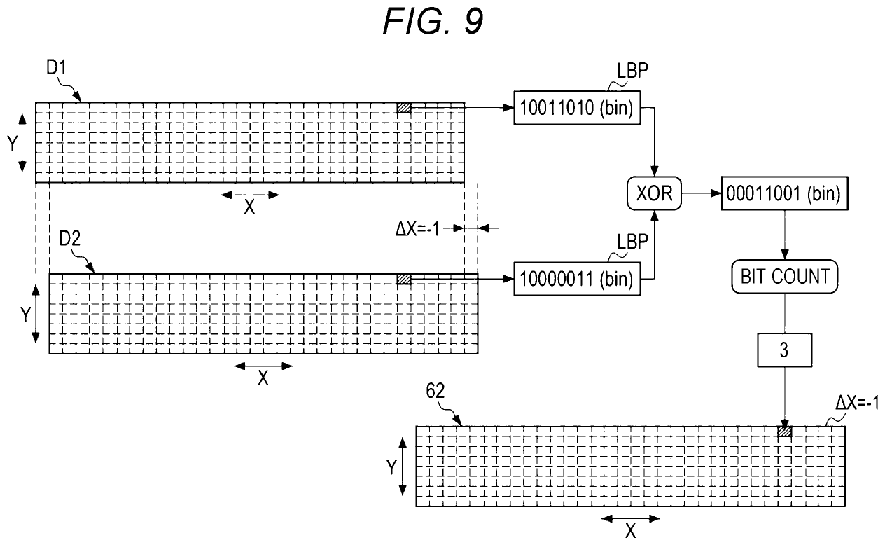

FIGS. 8 and 9 conceptually show an example of shift operation processing. FIG. 8 shows the shift operation when ΔX=0. FIG. 9 shows the shift operation when ΔX=−1.

The distance distribution information acquirer 53 reads the LBPs from the corresponding pixels of the first phase difference information D1 and the second phase difference information D2, and obtains an exclusive OR (XOR) of the two read LBPs. The distance distribution information acquirer 53 performs a bit count on the obtained XOR. The bit count refers to obtaining the number of “1” by counting “1” included in the XOR represented by a binary number. Hereinafter, the value obtained by the bit count is referred to as a “bit count value”. In the present embodiment, the bit count value is a value within a range of 0 to 8.

The distance distribution information acquirer 53 obtains the bit count value of the XOR for each of ΔX=2, 1, 0, −1, and −2 in all the corresponding pixels of the first phase difference information D1 and the second phase difference information D2. Accordingly, the difference map 62 is generated for each of ΔX=2, 1, 0, −1, and −2. Each pixel of the difference map 62 is represented by a bit count value.

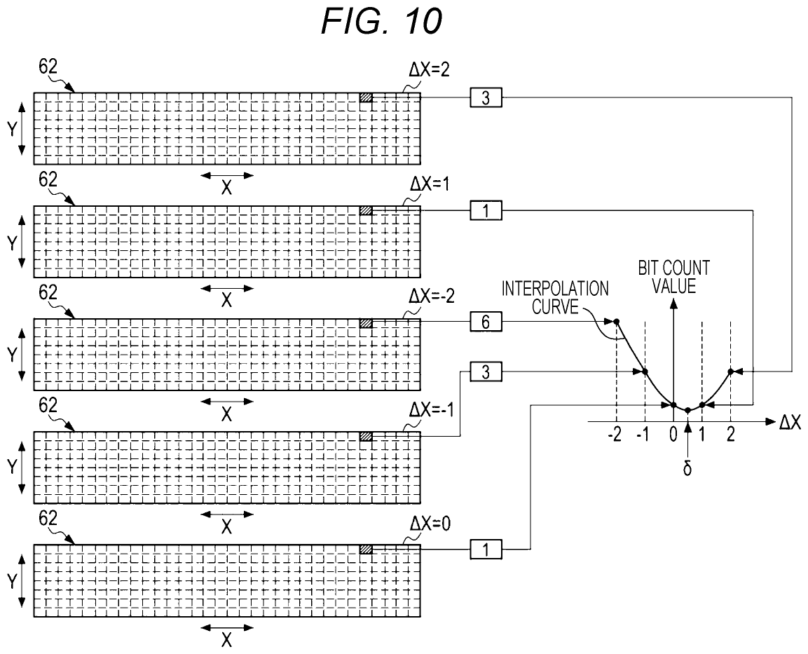

FIG. 10 conceptually shows an example of sub-pixel interpolation processing. As shown in FIG. 10, the distance distribution information acquirer 53 reads the bit count values from the corresponding pixels of the plurality of difference maps 62 generated by the shift operation processing, and plots the read bit count values against the shift amount ΔX. Then, the distance distribution information acquirer 53 obtains an interpolation curve by complementing the bit count value, and obtains a shift amount δ from a minimum value of the interpolation curve. The shift amount & represents a defocus amount, that is, a distance from the in-focus position. The relationship between the shift amount δ and the actual distance depends on a depth of field.

The distance distribution information 58 is generated by performing the sub-pixel interpolation processing for all the pixels of the difference map 62. Each pixel of the distance distribution information 58 is represented by the shift amount δ (defocus amount). The distance distribution information 58 corresponds to the captured image 56 and represents distance information of an object included in an imaging area in which the captured image 56 is acquired.

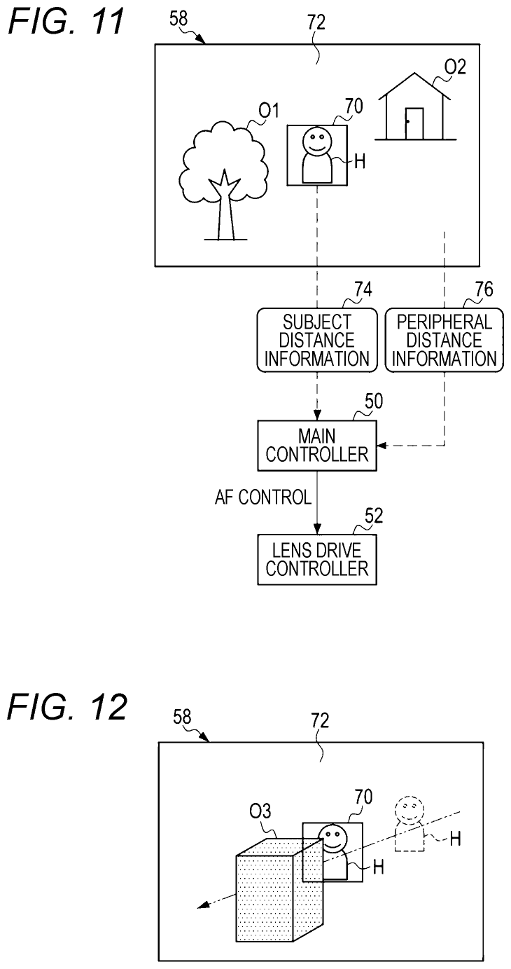

FIG. 11 conceptually shows an example of focusing control by the main controller 50. As shown in FIG. 11, based on the distance distribution information 58 acquired by the distance distribution information acquirer 53, the main controller 50 acquires subject distance information 74 indicating a distance to a subject existing in an AF area 70 and peripheral distance information 76 indicating a distance to an object existing in the peripheral region 72. In the example shown in FIG. 11, a subject H exists in the AF area 70, and objects O1 and O2 exist in the peripheral region 72. The AF area 70 is an example of a “focusing target region” according to the technique of the present disclosure.

The AF area 70 is, for example, a region including a subject designated by using the operation unit 13. The AF area 70 may be a region including a subject recognized by the main controller 50 by subject recognition based on the captured image 56. In a case where the subject H moves, the main controller 50 moves the AF area 70 so as to follow the subject H.

The main controller 50 performs focusing control for controlling the position of the focus lens 31 such that the subject H is in focus based on the subject distance information 74. Hereinafter, the focusing control based on the subject distance information 74 is referred to as AF control.

The main controller 50 interrupts or resumes the AF control during the AF control based on the subject distance information 74 and the peripheral distance information 76. Specifically, the main controller 50 detects an object existing between the subject H and the imaging device 10 including the imaging sensor 20 among the objects existing in the peripheral region 72 based on the subject distance information 74 and the peripheral distance information 76. The main controller 50 determines whether the detected object is close to the subject H. The detection of an object existing between the subject H and the imaging device 10 means detection of an object between the subject H and the imaging device 10 in a direction perpendicular to the imaging sensor 20. Therefore, the main controller 50 detects an object even in a case where the positions of the imaging device 10 and the subject H are deviated in a direction orthogonal to the perpendicular direction in a plane of the imaging sensor 20.

FIG. 12 describes occlusion of the subject H due to an object O3 existing between the subject H and the imaging sensor 20. In the example shown in FIG. 12, the subject H is moving in a direction approaching the object O3. Since the object O3 exists between the subject H and the imaging device 10, when the subject H continues to move, the object O3 blocks the subject H (that is, occlusion occurs). In this case, if the main controller 50 continues the AF control, when the object O3 blocks the subject H, the in-focus position moves from a position corresponding to the subject H to a position corresponding to the object O3 existing in front of the subject H. That is, in a case where the subject H moves and the object O3 temporarily blocks the subject H, the in-focus position varies. Similarly, in a case where the subject H does not move and the object O3 moves to block the subject H, the in-focus position varies.

In the present embodiment, the main controller 50 determines whether the object O3 existing between the subject H and the imaging device 10 is relatively close to the subject H, and changes the AF control when the object O3 approaches the subject H within a certain range. As a modification example of the AF control, there is an example in which the AF control is interrupted and the in-focus position before the interruption is maintained, or the AF control on the subject is forcibly continued and the in-focus position is maintained. In addition, the position of the subject H may be estimated based on a past position of the subject H (that is, a movement history of the subject H), and the focusing control may be executed for the estimated position.

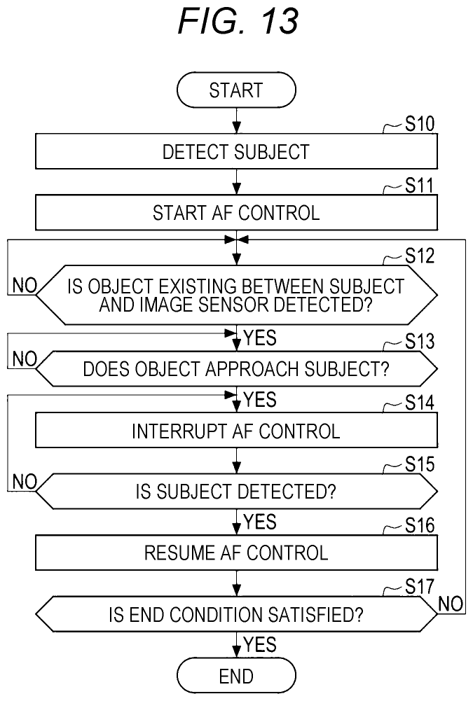

FIG. 13 is a flowchart showing an example of the AF control of the main controller 50. As shown in FIG. 13, first, the main controller 50 detects the subject H from the AF area 70 (step S10). The main controller 50 starts the AF control such that the detected subject H is brought into a focus state based on the subject distance information 74 (step S11).

The main controller 50 starts the AF control, and then performs detection processing of detecting the object O3 existing between the subject H and the imaging sensor 20 based on the subject distance information 74 and the peripheral distance information 76 (step S12). When the main controller 50 does not detect the object O3 (step S12: NO), the main controller 50 performs the detection processing again. When detecting the object O3 (step S12: YES), the main controller 50 determines whether the object O3 approaches the subject H within a certain range (step S13). When the object O3 does not approach the subject within a certain range (step S13: NO), the main controller 50 performs the determination again.

When determining that the object O3 approaches the subject H within a certain range (step S13: YES), the main controller 50 interrupts the AF control (step S14). When the AF control is interrupted, the in-focus position before the interruption is maintained.

The main controller 50 determines whether the subject H is detected again (step S15), and when the subject H is not detected (step S15: NO), the main controller 50 returns the processing to step S14. That is, the main controller 50 interrupts the AF control until the subject H is detected again. When the subject H is detected again (step S15: YES), the main controller 50 resumes the AF control (step S16).

Next, the main controller 50 determines whether an end condition is satisfied (step S17). The end condition is, for example, an end operation performed by the user using the operation unit 13. In a case where the end condition is not satisfied (step S17: NO), the main controller 50 returns the processing to step S12. In a case where the end condition is satisfied (step S17: YES), the main controller 50 ends the AF control.

As described above, in the imaging device 10 according to the embodiment of the present disclosure, since the AF control is interrupted and the in-focus position before the interruption is maintained in a case where occlusion occurs in the subject, it is possible to accurately follow the subject. It is preferable that the AF control according to the present embodiment is applied at the time of live view display. Since the in-focus position does not vary even if occlusion occurs in the subject as a focusing target, the visibility of the live view display is improved.

Various modification examples of the embodiment will be described below.

### First Modification Example

In the embodiment, the AF control is interrupted when the object O3 existing in front of the subject H approaches the subject H. In contrast, in this modification example, the position of the subject H is estimated based on the past position of the subject H (that is, the movement history of the subject H) without interrupting the AF control, and the AF area 70 is moved to the estimated position.

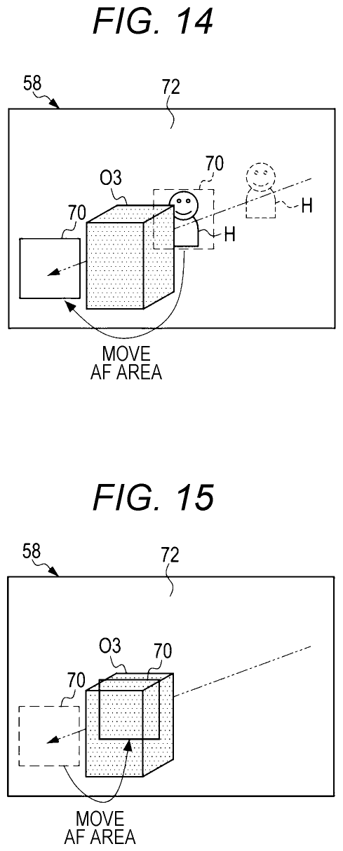

FIG. 14 conceptually shows an example in which the AF area 70 is moved in a case where occlusion occurs in the subject H due to the object O3. As shown in FIG. 14, in a case where it is estimated that the subject H moves in a direction approaching the object O3 and the object O3 is blocked by the subject H, the main controller 50 estimates a position where the subject H appears again after the subject H is blocked by the object O3, based on the movement history of the subject H. Then, the main controller 50 moves the AF area 70 to the estimated position.

After moving the AF area 70, in a case where the subject H is not detected in the AF area 70 after the movement, the main controller 50 moves the AF area 70 again.

FIG. 15 shows an example of a case where the AF area 70 is moved again. After moving the AF area 70 as shown in FIG. 14, when the subject H is not detected in the AF area 70 after the movement, the main controller 50 estimates that the subject H is still blocked by the object O3. As shown in FIG. 15, the main controller 50 moves the AF area 70 to the position of the object O3. As a result, the object O3 becomes a focusing target.

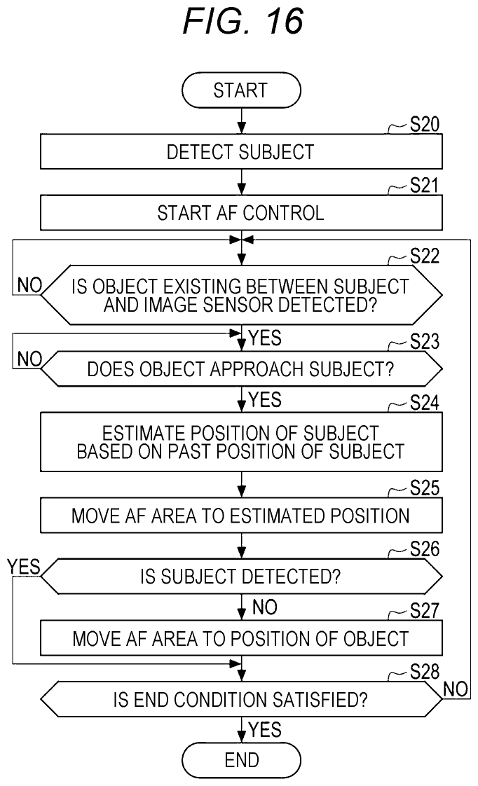

FIG. 16 is a flowchart showing an example of the AF control according to a first modification example. Steps S20 to S23 shown in FIG. 16 are processing similar to steps S10 to S13 shown in FIG. 13. In this modification example, in a case where determining that the object O3 approaches within a certain range with respect to the subject H (step S23: YES), the main controller 50 estimates the position of the subject H based on the past position of the subject H (step S24). The main controller 50 moves the AF area 70 to the estimation position (step S25).

The main controller 50 determines whether the subject H is detected again from the AF area 70 after the movement (step S26), and in a case where the subject H is not detected (step S26: NO), the main controller 50 moves the AF area 70 to the position of the object O3 (step S27). On the other hand, in a case where the subject H is detected from the AF area 70 after the movement (step S26: YES), the main controller 50 shifts the processing to step S28. In step S28, the main controller 50 determines whether an end condition is satisfied (step S28). The end condition is, for example, an end operation performed by the user using the operation unit 13. When the end condition is not satisfied (step S28: NO), the main controller 50 returns the processing to step S22. When the end condition is satisfied (step S28: YES), the main controller 50 ends the AF control.

### Second Modification Example

In the embodiment described above, the AF control based on the subject distance information 74 and the peripheral distance information 76 has been described. In this modification example, the image processing unit 52 performs correction processing on at least one of the AF area 70 or the peripheral region 72 of the captured image 56.

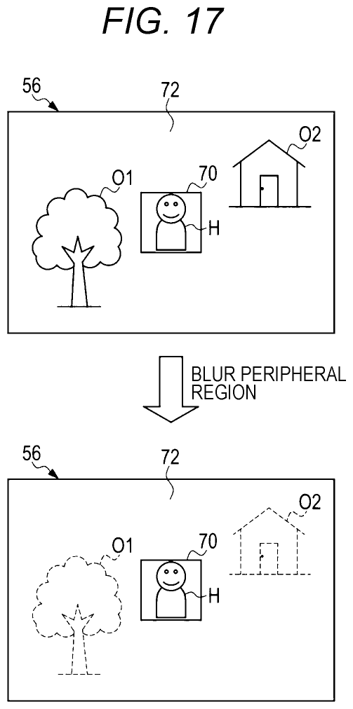

FIG. 17 conceptually shows an example of correction processing according to a second modification example. As shown in FIG. 17, the image processing unit 52 performs the correction processing of blurring only the peripheral region 72. Accordingly, the objects O1 and O2 existing in the peripheral region 72 are blurred, and the subject H in a focus state in the AF area 70 can stand out in an impressive manner.

The peripheral distance information 76 includes relative distances of the objects O1 and O2 in the peripheral region 72 with respect to the AF area 70. Therefore, the image processing unit 52 may change a correction content (for example, a blurring amount) in accordance with the distance to each of the objects O1 and O2 in the peripheral region 72. For example, the image processing unit 52 sets the blurring amount for the object existing on the front side of the in-focus position to be larger than the blurring amount for the object existing on the back side of the in-focus position.

Since the subject in the AF area 70 and the object in the peripheral region 72 can be accurately distinguished at a high speed by performing the correction by using the subject distance information 74 and the peripheral distance information 76, the speed of the correction is increased. The correction processing according to this modification example is not limited to the blurring correction, and may be brightness correction. For example, the image processing unit 52 distinguishes between the subject in the AF area 70 and the object in the peripheral region 72, and corrects the brightness of the subject. The image processing unit 52 may distinguish the subject in the AF area 70 from the object in the peripheral region 72, and may perform correction to reduce the luminance of the peripheral object. The image processing unit 52 may perform chromatic aberration correction on the object in the peripheral region 72 by using the subject distance information 74 and the peripheral distance information 76.

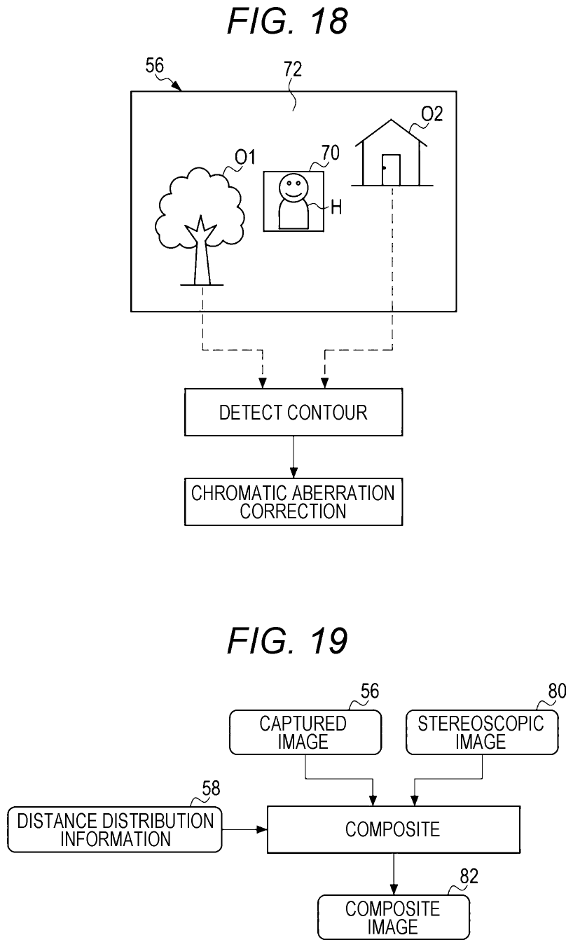

FIG. 18 conceptually shows the chromatic aberration correction. As shown in FIG. 18, the image processing unit 52 detects the contours of the objects O1 and O2 existing in the peripheral region 72, and performs the chromatic aberration correction on the detected contours. The chromatic aberration correction is processing of correcting the color of an end part such as a contour for each pixel. For example, the chromatic aberration correction is correction of changing the color of the pixel of the contour or correction of reducing the saturation of the end part. In addition, the chromatic aberration correction may be correction processing such as gradation correction of applying gradation to the end part.

The chromatic aberration occurring in the contour of the object in the peripheral region 72 is mainly caused by axial chromatic aberration, but may be caused by lateral chromatic aberration. The chromatic aberration is unevenness that occurs depending on the distance of the subject from the imaging device 10, and the color of the unevenness and the size of the unevenness are different. Therefore, the image processing unit 52 may change the correction content or the like of the chromatic aberration correction in accordance with the distance to the object existing in the peripheral region 72. That is, the image processing unit 52 may perform the correction processing on the object as the correction processing to be performed on the peripheral region or may change the correction processing on the object in accordance with the relative distance of the object in the peripheral region with respect to the focusing target region. In addition, the image processing unit 52 may change the correction content or the like of the chromatic aberration correction depending on whether the object existing in the peripheral region 72 exists in front of the subject in the AF area 70 or exists on the back side the subject in the AF area 70 (that is, in a state of a front focus or a rear focus).

### Third Modification Example

In this modification example, the image processing unit 52 generates a composite image. FIG. 19 conceptually shows an example of composite image generation processing. In a case where generating a composite image 82 by compositing the captured image 56 and a stereoscopic image 80, the image processing unit 52 performs registration between the captured image 56 and the stereoscopic image 80 by using the distance distribution information 58. The stereoscopic image 80 is, for example, a graphic image used in AR, and the composite image 82 is a so-called AR image. The distance distribution information 58 includes distance information corresponding to a plurality of pixels constituting the captured image 56. Therefore, since the distance can be ascertained in units of pixels, it is possible to reduce a deviation between the captured image 56 and the stereoscopic image 80 even in a case where the number of subjects is large or the shape of the subject is complicated.

In the embodiment, the following various processors can be used as a hardware structure of a controller such as the processor 40. The various processors include a CPU that is a general-purpose processor functioning by executing software (program) and a processor such as an FPGA of which a circuit configuration can be changed after manufacturing. The FPGA includes a dedicated electric circuit that is a processor having a circuit configuration specially designed to execute specific processing such as a PLD or an ASIC.

The controller may include one of the above various processors, or may include a combination of two or more processors of the same type or different types (for example, a combination of a plurality of FPGAs or a combination of a CPU and an FPGA). A plurality of controllers may be constituted by one processor.

A plurality of examples are considered in which a plurality of controllers are constituted by one processor. As a first example, as represented by computers of a client, a server, and the like, there is a form in which one processor is constituted by a combination of one or more CPUs and software, and this processor functions as a plurality of controllers. As a second example, as represented by a system-on-chip (SOC) and the like, there is a form in which a processor that implements the functions of the entire system including a plurality of controllers with one IC chip is used. As described above, the controller can be constituted by using one or more of the various processors as a hardware structure.

Furthermore, as a hardware structure of these various processors, more specifically, an electrical circuit in which circuit elements such as semiconductor elements are combined can be used.

The contents of the description and the contents of the drawings are detailed description for parts according to the technique of the present disclosure and are merely one example of the technique of the present disclosure. For example, the above description regarding the configuration, function, action, and effect is a description regarding an example of the configuration, function, action, and effect of the parts according to the technique of the present disclosure. Accordingly, it goes without saying that deletion of unnecessary parts, addition of new elements, or replacement are permitted in the contents of the description and the contents of the drawings without departing from the gist of the technique of the present disclosure. In addition, in order to avoid complication and facilitate understanding of the parts according to the technique of the present disclosure, description of common technical knowledge and the like that does not need to be described to enable implementation of the technique of the present disclosure is omitted in the contents of the description and the contents of the drawings indicated above.

All the documents, patent applications, and technical standards described in this specification are herein incorporated by reference to the same extent as if each individual publication, patent application, or technical standard was specifically and individually indicated to be incorporated by reference.

What is claimed is:

1. An imaging device comprising:
an image sensor that has a plurality of first phase difference pixels and a plurality of second phase difference pixels, and outputs a captured image; and
at least one processor,
wherein the at least one processor is configured to:
convert signals obtained from the plurality of first phase difference pixels and the plurality of seconds phase difference pixels into first phase difference information and second phase difference information by using a local binary encoding method;
acquire distance distribution information corresponding to the captured image by performing a shift operation on the first phase difference information on the second phase difference information; and
acquire subject distance information indicating a distance to a subject existing in a focusing target region and peripheral distance information indicating a distance to an object existing in a peripheral region of the focusing target region based on the distance distribution information.

2. The imaging device according to claim 1, further comprising:
a focus lens,
wherein the at least one processor is configured to perform focusing control of controlling a position of the focus lens based on the subject distance information.

3. The imaging device according to claim 2, wherein the at least one processor is configured to:
detect an object existing between the subject and the imaging device based on the subject distance information and the peripheral distance information; and
in a case where a distance within an angle of view of the object with respect to the subject is reduced, change the focusing control.

4. The imaging device according to claim 3, wherein the at least one processor is configured to
estimate a position of the subject based on a past position of the subject in a case where the object blocks the subject.

5. The imaging device according to claim 3, wherein the at least one processor is configured to:
move the focusing target region to the estimated position of the subject; and
in a case where the subject is not detected from the focusing target region after the movement, move the focusing target region to a position of the object.

6. The imaging device according to claim 1, wherein the at least one processor is configured to:
record the captured image and the distance distribution information; and
acquire the subject distance information and the peripheral distance information based on the distance distribution information.

7. The imaging device according to claim 6, wherein the at least one processor is configured to
generate and record an image file including the captured image and the distance distribution information.

8. The imaging device according to claim 6,
wherein the peripheral distance information included in the distance distribution information includes a relative distance of an object in the peripheral region with respect to the focusing target region.

9. The imaging device according to claim 8, wherein the at least one processor is configured to
perform correction processing on at least one of the focusing target region or the peripheral region of the captured image based on the distance distribution information.

10. The imaging device according to claim 9, wherein the at least one processor is configured to
change the correction processing on the object in accordance with the relative distance.

11. The imaging device according to claim 10,
wherein the correction processing on the object is chromatic aberration correction.

12. The imaging device according to claim 6,
wherein the distance distribution information includes distance information corresponding to a plurality of pixels constituting the captured image, and
the at least one processor is configured to
composite a stereoscopic image with the captured image by using the distance information to generate a composite image.

13. A method of driving an imaging device including an image sensor that has a plurality of first phase difference pixels and a plurality of second phase difference pixels, and outputs a captured image, the method comprising:
converting signals obtained from the plurality of first phase difference pixels and the plurality of seconds phase difference pixels into first phase difference information and second phase difference information by using a local binary encoding method;
acquiring distance distribution information corresponding to the captured image by performing a shift operation on the first phase difference information on the second phase difference information; and
acquiring subject distance information indicating a distance to a subject existing in a focusing target region and peripheral distance information indicating a distance to an object existing in a peripheral region of the focusing target region based on the distance distribution information.

14. A non-transitory computer-readable storage medium storing a program that operates an imaging device including an image sensor that has a plurality of first phase difference pixels and a plurality of second phase difference pixels, and outputs a captured image, the program causing the imaging device to perform processing of:
converting signals obtained from the plurality of first phase difference pixels and the plurality of seconds phase difference pixels into first phase difference information and second phase difference information by using a local binary encoding method;
acquiring distance distribution information corresponding to the captured image by performing a shift operation on the first phase difference information on the second phase difference information; and
acquiring subject distance information indicating a distance to a subject existing in a focusing target region and peripheral distance information indicating a distance to an object existing in a peripheral region of the focusing target region based on the distance distribution information.

15. The imaging device according to claim 1, wherein the at least one processor is configured to
perform phase difference method focus adjustment by performing the shift operation based on the signals obtained from the plurality of first phase difference pixels and the plurality of seconds phase difference pixels, and
wherein the shift range of the shift operation in acquiring the distance distribution information is narrower than the shift range of the shift operation in the phase difference method focus adjustment.

16. The imaging device according to claim 1, wherein the at least one processor is configured to:
distinguish the subject existing in the focusing target region from the object existing in the peripheral region based on the subject distance information and the peripheral distance information; and
perform correction to reduce the luminance of the object.
